(19) United States
(12) Patent Application Publication
(10) Pub. No.: US 2007/0215533 A1
(43) Pub. Date: Sep. 20, 2007

(54) Filter With Support Cage

(75) Inventor: Jochen Tittgen, Bunde (DE)

Correspondence Address: THE H.T. THAN LAW GROUP, WATERFRONT CENTER SUITE 560, 1010 WISCONSIN AVENUE NW, WASHINGTON, DC, 20007, US

(73) Assignee: DR. TITTGEN BIOTECHNOLOGIE, Bünde (DE)

(21) Appl. No.: 10/599,489

(22) PCT Filed: Mar. 30, 2004
(86) PCT No.: PCT/EP04/03366

§ 371 Date: Nov. 9, 2006

(51) Int. Cl. B01D 15/08

(52) U.S. Cl. 210/198.2; 210/485

(57) ABSTRACT

The invention relates to a filter element for a chromatographic column (1), comprising
a support cage (3) whose outer contour defines a cylinder open on one side, and
a filter (10) which abuts the inside of the support cage (3).

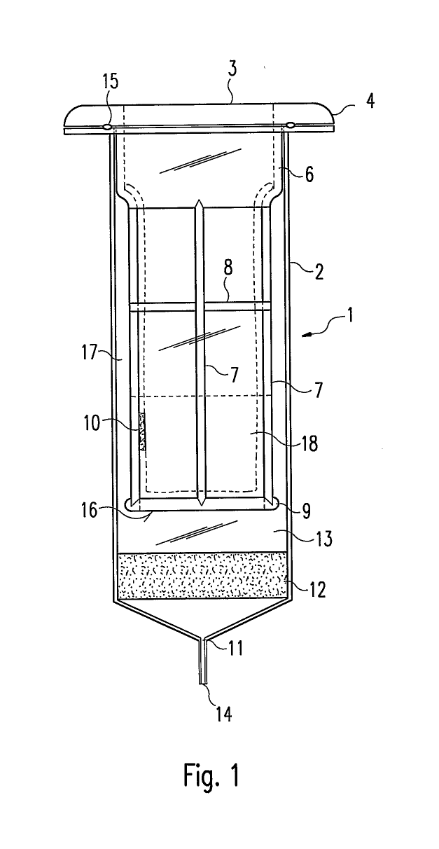

The invention further provides a chromatographic separating column which has a syringe-shaped column element (2) which is open at one end and is provided at the other end with a tapered outlet (11) and into which such a filter element (3, 10) has been inserted.

The present invention relates generally to chromatographic separating columns as well as to filters for such chromatographic columns. Devices of this type can be used, for example, for separating nucleic acids.

Methods of separating nucleic acids and apparatuses for carrying out such a method having filter devices of the generic type are known, for example, from DE 102 01 858 A1. More precisely, this document discloses a separating device which substantially comprises a plastics column in which there are arranged chromatography material and a filter material provided upstream of the chromatography material. The filter material thereby forms, without the provision of plastics components, by appropriate folding of paper material, a substantially cylindrical body which can be inserted into the plastics column and removed again after use. The folded paper cylinder is not dimensionally stable but rather more or less fills the inside of the separating column.

The object of the present invention is to improve this known separating device of the generic type so that correct positioning of the filter material is ensured even when a smaller amount of (paper) filter material that is not dimensionally stable is used.

More precisely, the object is achieved by the features of the independent claims, the dependent claims developing the invention further in a particularly advantageous manner.

According to a first aspect of the present invention there is provided a filter element for a chromatographic column, which filter element comprises:
a support cage whose contour defines a cylinder open on one side, and
a filter which abuts the inside of the support cage and defines a hollow space which is open on one side.

The support cage can have a substantially annular collar at its open end.

The support cage can preferably have, in the region adjoining the collar, a sleeve-like portion having a closed outer surface, the outside diameter of which extends over the outer contour of the support cage.

The support cage can be manufactured from a plastics material.

The outer contour of the support cage can be formed by longitudinal struts and at least one annular strut.

The end face of the support cage can be defined by at least one transverse strut.

The filter can be fixedly joined, in particular adhesively bonded, to the inside of the support cage.

The filter can be manufactured from a paper material which lines the inner contour of the support cage in a single layer.

According to a further aspect there is provided a chromatographic separating column having a syringe-shaped column element which is open at one end and is provided at the other end with a tapered outlet and into which a filter element of the above-mentioned type has been inserted.

The support cage can thereby be of such a size that at least part of its outer surface abuts the inside of the column element.

At least part of the outer surface of the support cage, in particular the sleeve-like portion, can abut the inside wall of the column element in a frictionally engaged manner, while the remaining part of the outer surface is at a distance from the inside wall of the column element.

The collar of the support cage can rest on the open end of the column element or on a flange provided there, the length of the filter element being such that a gap is formed between the closed end face of the support cage and the outlet of the column element.

Chromatography material can be provided in the gap.

In the region of its open end, the support cage can be joined directly or indirectly to the column element in a gas-tight manner by means of a separate sealing element or a sealing element joined to the support cage.

According to yet a further aspect of the present invention there is provided a chromatography apparatus which comprises a separating column of the above-mentioned type as well as a device for applying a partial vacuum to the outlet of the separating column.

Finally, a chromatographic column is proposed which comprises:
a syringe-shaped column element which is open at one end and is provided at the other end with a tapered outlet,
a filter inserted into the column element, the filter being plane and delimiting a hollow space which is open on one side in the direction of the open end of the column element.

If the filter material has the appropriate strength, it is therefore possible for the support cage optionally to be omitted, if the filter material has sufficient dimensional stability to incorporate the function of the support cage. The filter material, which is in the form of a sleeve, can be joined (e.g. welded or adhesively bonded) at the edges to a collar, for example as defined above of a plastics material, which ensures correct positioning relative to the column.

If desired, the filter can be held in shape even better by partial elements of a cage, that is to say stiffening rings or struts. It is therefore not necessary for the cage to be constructed fully.

Further features, advantages and properties will now be explained in greater detail with reference to the single FIGURE of the accompanying drawing. This FIGURE shows a diagrammatic view of a chromatographic separating column according to the invention having a filter element with a support cage.

As can be seen in the FIGURE, the main components of the chromatographic column 1 according to the invention are a filter element consisting substantially of a support cage 3 and a filter 10, the chromatography material 12 and also a substantially syringe-shaped column element 2 into which the filter element has been inserted.

The form of the support cage 3, in particular the dimensions of the gaps between the struts of the support cage, is chosen in dependence on the strength (stiffness, carrying capacity, etc.) of the filter material used.

As already stated, the filter element consists substantially of a support cage 3 which can be manufactured, for example for example, from a plastics material by injection moulding. The filter 10, for example of a flat material, such as, for example, a single-layer paper material, has been inserted into the support cage 3 in such a manner that the filter 10 lines the inside of the end face 16 and the outer surface of the substantially cylindrical support cage 3. The filter 10 can be fixedly joined, for example by adhesive bonding, to the inside surfaces of the longitudinal struts 7 and transverse rings 8, 9 forming the support cage 3. It is thus ensured that, during the filtering operation, the single-layer paper filter layer is always held correctly in the position defined by the shape of the support cage 3, which is rigid compared with the filter material.

Of course, it is also possible for the filter material to be in a plurality of layers, it being possible for the several layers to be joined to one another. The outermost layer at least should be joined to the support cage 3.

The flat filter material is held by the support cage in a smooth, substantially fold-free form, which delimits a hollow space that is open on one side.

The actual cage region 17, which is formed by the mentioned longitudinal struts 7 and transverse struts 8, 9, is followed by a sleeve-like portion 6 whose outer surface, unlike that of the actual cage region 17, is closed, as can be seen diagrammatically in the FIGURE. In addition, the outer contour of the sleeve-like portion 6 is has a larger diameter than that of the cage region 17.

Adjacent to the sleeve-like portion 6 there is in turn a collar 4.

In order to ensure that the filter material 10 is held correctly in position also at the end face, it is possible to provide, in addition to the longitudinal strut 9, also a diagonal strut (not shown in the FIGURE) on which the filter material can be supported at the end face.

The mentioned filter element consisting of the support cage 3 and the filter 10 can be inserted into a syringe-shaped plastics column 2 from the open end thereof. In the inserted state shown in the FIGURE, the filter element is suspended by its collar 4 on the open end of the plastics column 2, it being possible for that end also to be widened in the manner of a flange, as shown in the FIGURE (see reference numeral 5).

The outside diameter of the sleeve-like portion 6 of the filter element is preferably such that the filter element abuts the inside wall of the plastics column 2 in this region in a frictionally engaged manner. Furthermore, it is possible for the filter element to terminate in a substantially air-tight manner with the plastics column 2 in the region of the sleeve-like portion 6 and/or of the collar 4. This can optionally be assisted by separate sealing elements (O-ring 15) or sealing elements formed integrally with the filter element 3.

As can be seen from the FIGURE, the support cage 3 is in contact with the plastics column 2 only in the region of the collar 4 and the widened sleeve-like portion 6. The remaining part of the support cage 3, on the other hand, and in particular the actual cage region 17 with the annular struts 8, 9 and the longitudinal struts 7, is at a distance from the inside wall of the plastics column 2.

In addition, the longitudinal dimensions of the support cage 3 can be such that a gap 13 is formed between the end face 16 of the support cage 3 and the outlet 11 of the chromatographic separating column, which gap 13 can be filled at least partly with chromatography material 12. This chromatography material 12 can be suitable, for example, for separating a nucleic acid mixture. Chromatography material described in documents EP 744 025 B1 and EP 1 242 816 B1 is particularly suitable for this purpose. The end face 16 of the support cage 3 is at a sufficient distance from the chromatography material 12 when the filter element is pushed fully into the column.

Depending in particular on the nature and density of the chromatography material 12 used, it can be sufficient to arrange the chromatographic separating column shown diagrammatically in the FIGURE vertically and to introduce the material to be treated into the hollow space 18 formed by the support cage 3 and the filter 10, so that it passes through the filter material 10 and subsequently through the chromatography material 12 solely under the effect of gravity.

However, it may also be necessary to apply a vacuum to the outlet region 14 of the separating column 2. In this case in particular, it must be ensured that there is an air-tight seal between the filter element and the inside wall of the separating column 2 in the region of the sleeve-like portion 6 and/or of the collar 4 of the support cage 3.

According to the invention, therefore, correct orientation of the filter 10 during operation is ensured by the secure positioning of the filter material 10 in the support cage 3 and the positioning of the support cage 3 in the separating column 12, which is ensured by the appropriate construction of the support cage 3, even though the chosen single-layer filter material is not itself dimensionally stable. Rather, dimensional stability is ensured by the support cage 3.

In the prior art (DE 102 01 858 A1), the paper filter material itself is not dimensionally stable; rather, correct positioning must be ensured by completely filling the inside of the separating column for specifying the positioning of the filter. However, because the shape of the filter in the present invention is not specified by the filter material and/or the separating column 2 but by the appropriate selection of the shape of the support cage 3, a variety of design possibilities are opened up, even in respect of more complex filter shapes.

Finally, a chromatographic column is proposed which comprises:
a syringe-shaped column element which is open at one end and is provided at the other end with a tapered outlet, and
a filter inserted into the column element, the filter being flat and delimiting a hollow space which is open on one side in the direction of the open end of the column element.

If the filter material has the appropriate strength, it is therefore possible for the support cage optionally to be omitted, if the filter material has sufficient dimensional stability to incorporate the function of the support cage. The filter material, which is in the form of a sleeve, can be joined (e.g. welded or adhesively bonded) at the edges to a collar, for example as defined above of a plastics material, which ensures correct positioning relative to the column. If desired, the filter can be held in shape even better by partial elements of a cage, that is to say stiffening rings or struts. It is therefore not necessary for the cage to be constructed fully.

1-14. (canceled)

15. A filter element for a chromatographic column (1), comprising
a support cage (3) whose contour defines a cylinder open on one side, and
a filter (10) which abuts the inside of the support cage (3) and defines a hollow space which is open on one side,
wherein the support cage (3) has at its open end a substantially annular collar (4), and
wherein the filter (2) is fixedly joined to the inside of the support cage (3).

16. A filter element according to claim 1, wherein the support cage (3) preferably has, in the region adjacent to the collar (4), a sleeve-like portion (6) having a closed outer surface, the outside diameter of which extends over the outer contour of the support cage (3).

17. A filter element according to claim 1, wherein the support cage (3) has been manufactured from a plastics material.

18. A filter element according to any one of the preceding claims, wherein the outer contour of the support cage is formed by longitudinal struts (7) as well as at least one annular strut (8).

19. A filter element according to claim 1, wherein the end edges of the support cage (3) are defined by at least one transverse strut (9).

20. A filter element according to claim 1, wherein the filter (10) has been manufactured from a paper material.

21. A filter element according to claim 20, wherein the paper material lines the inner contour of the support cage (3) in a single layer.

22. A chromatographic separating column, wherein it has a syringe-shaped column element (2) which is open at one end and is provided at the other end with a tapered outlet (11) and into which a filter element (3, 10) according to any one of the preceding claims has been inserted.

23. A chromatographic separating column according to claim 22, wherein the size of the support cage (3) is such that at least part of its outer surface abuts the inside of the column element (2).

24. A chromatographic separating column according to claim 23, wherein at least part of the outer surface of the support cage (3), in particular the sleeve-like portion (6), abuts the inside wall of the column element (2) in a frictionally engaged manner, while the remaining part of the outer surface is at a distance from the inside wall of the column element (2).

25. A chromatographic separating column according claim 22, wherein the collar (4) of the support cage (3) rests on the open end (5) of the column element (2), the length of the filter element being such that a gap (13) is formed between the closed end face of the support cage (3) and the outlet of the column element (2).

26. A chromatographic separating column according to claim 25, wherein chromatography material (12) is provided in the gap (13).

27. A chromatographic separating column according to claim 22, wherein the support cage (3), in the region of its open end, is joined directly or indirectly to the column element (2) in an air-tight manner by means of a separate sealing element (15) or a sealing element (15) joined to the support cage (3).

28. A chromatographic separating device according to claim 22, wherein it has a separating column (2) as well as a device for applying a partial vacuum (14) to the outlet (11) of the separating column.
